(19) United States
(12) Patent Application Publication
(10) Pub. No.: US 2003/0075142 A1
(43) Pub. Date: Apr. 24, 2003

(54) System and method for controlling a gasoline direct injection ignition system

(76) Inventor: Artur P. Suckewer, Princeton, NJ (US)

Correspondence Address: WOLF GREENFIELD & SACKS, PC, FEDERAL RESERVE PLAZA, 600 ATLANTIC AVENUE, BOSTON, MA, 02210-2211, US

(21) Appl. No.: 10/147,724

(22) Filed: May 16, 2002

Related U.S. Application Data
(60) Provisional application No. 60/291,235, filed on May 16, 2001.

(51) Int. Cl. F02P 1/00

(52) U.S. Cl. 123/305; 123/612; 123/406.47; 123/620

(57) ABSTRACT

In one embodiment, the present invention is directed to a method of igniting a fuel charge of a Gasoline Direct Injection engine. The method of this embodiment includes providing an ignition pulse to an ignitor, the pulse having a duration of at least 1 μs and an average power of at least 500W.

### CROSS REFERENCE TO RELATED APPLICATIONS

This application claims the benefit of prior filed provisional application No. 60/291,235, filed May 16, 2001 and entitled SYSTEM AND METHOD FOR CONTROLLING A GASOLINE DIRECT INJECTION IGNITION SYSTEM, which is incorporated herein by reference.

### BACKGROUND

1. Field of the Invention

The present invention specifies energy and timing requirements for the ignition pulse in gasoline direct injection engines.

2. Background

A GDI engine is a crossover between a spark ignited Otto cycle spark ignition engine and a compression ignited Diesel cycle engine. The concept is to spray fuel directly into the combustion chamber of an engine, but have the fuel ignited by the spark plug (spark ignition, “SI”) rather than the high compression as in a Diesel engine (compression ignition, “CI”). One of the benefits of this approach is the ability of an engine to operate in a stratified charge mode, which, like in Diesel type engines, allows engines to run with fuel mixtures significantly leaner than stoichiometric. However, the reliability and quality of the ignition process is poor in comparison to CI systems.

The amount of energy used to compress the fuel that is transferred to the fuel mixture in the CI ignition process is significantly greater than the amount of energy delivered by a standard ignition source used in SI engines.

The reliability of the ignition event depends on many factors, including ignitability of the fuel mixture (fuel type, uniformity of the mixture, extent of its vaporization and atomization, etc.), and the energy delivered to the ignited fuel mixture by the ignition source (ignition kernel). Two parameters specify the energy of the ignition source: power of the ignition source and its duration. However, there is a threshold for the power of the ignition source, below which the quality of the resulting combustion initiation is low. Although the ignition systems presently used in GDI engines are of higher energy than the Kettering type ignition systems used on non-GDI SI engines, the energy is used mainly for extending the duration of the ignition spark up to 30° of crank angle, in some cases even beyond that, in the attempt to create a quasi Diesel cycle. In a Diesel cycle, fuel ignites as it is injected into the combustion chamber, and the ignition event continues for the duration of the fuel injection event. In many GDI engines, a quasi-Diesel ignition is attempted by delivering a single long duration discharge or a series of discharges of short duration (multi-strike ignition),while fuel is injected into a combustion chamber. However, the power of each discharge generated by the ignition systems is often too low for a consistent and efficient ignition process, compromising the performance and efficiency expected from GDI technology. These problems can be addressed by improving the fuel mixture preparation or increasing the electric power of the ignition source.

### SUMMARY OF THE INVENTION

In one embodiment, the present invention is directed to a method of igniting a fuel charge of a Gasoline Direct Injection engine. The method of this embodiment includes providing an ignition pulse to an ignitor, the pulse having a duration of at least 1 μs and an average power of at least 500W.

In another embodiment, the present invention is directed to a Gasoline Direct Injection engine timing. The method includes (a) setting the ignition timing at a fixed delay from the injector timing and, (b) following act (a) adjusting the injector timing relative to the crank angle until the desired ignition timing relative to the injection timing is achieved In another embodiment, the present invention is directed to a method of operating a Gasoline Direct Injection engine. The method of this embodiment includes, in sequence, acts of: (a) determining a time when the fuel injector changes state; (b) delaying for a predetermined time; and (c) triggering an ignition sequence after the delay.

In another embodiment, the present invention is directed to method of operating a Gasoline Direct Injection engine. This embodiment includes coupling the ignition timing directly to the injector signal and adding a delay, wherein the delay is greater that or equal to 0.

### BRIEF DESCRIPTION OF THE DRAWINGS

The foregoing, and other objects and advantages will be understood more clearly from the following detailed description and from the accompanying figures. The following description and the figures related thereto are given by way of example only and in no way restrict the scope of the present invention. In the figures:

FIG. 1a is an example of an output voltage waveform of a FICHT injector coil;

FIG. 1b shows an example of an injector coil with the location where the waveform of FIG. 1a may be taken from;

FIG. 2 shows an one example of a circuit which creates an output pulse at its output after the occurrence of the voltage spike associated with the closing of an injector; and

FIG. 3 depicts schematically the timing and duration of the injection and ignition events.

### DETAILED DESCRIPTION

As discussed above, for spark ignited (SI) Gasoline Direct Injection (GDI) engines, the reliability of an ignition event depends to a great degree on the power and volume of the ignition kernel, and precise synchronization of the timing of the ignition discharge and the fuel injection events.

Solving ignition problems in the GDI engine by increasing the electric energy and volume of the ignition source is simpler and less expensive in comparison with other options. The power of the ignition source presents a simple first approximation of these parameters. A high power ignition source provides sufficient energy for rapid fuel particle (droplet) vaporization during its interaction with the fuel spray. This leads to a robust and reliable combustion process. With the combustion initiation quality ameliorated by the high power ignition source the demand for discharge pulse duration is drastically reduced.

We have demonstrated excellent combustion with a KSI type ignition system. Examples of a KSI type ignitors, ignition systems and methods for generating high volume, high powered ignition kernels of short duration are disclosed, for example in U.S. Pat. Nos. 5,704,321; 6,131,542; and 6,321,733B. Of course, other ignition systems may be used as well.

In tests conducted on a spray-guided GDI system with relatively poor fuel preparation and consistency, we have demonstrated dramatic improvements in the combustion process with a peak electric power of the ignition source ranging from 10 kW to 55 kW, preferably >35 kW. Further increases in power may lead to further gains in combustion quality. The ignition discharge pulse duration ranged from 7 μs to 100 μs, with preferred discharge pulse duration>35 μs. For most spray-guided applications a discharge pulse duration>100 μs was not necessary.

The ignition source energy requirements decreased with improved quality of fuel mixtures. In the more refined systems an ignition discharge pulse peak power as low as 1.5 kW and discharge duration as low as 1 μs are sufficient. In wall-guided GDI systems the demand for ignition discharge power is lower than in spray-guided systems, however demand for the discharge duration is increased. The ignition discharge pulse power averaging as low as 0.5 kW is possible, and a relatively long discharge pulse duration—longer than 50 μs is preferred.

As discussed earlier, for spark ignited gasoline direct injection (GDI) engines, it is important to know when the fuel cloud is passing the ignitor. In the case of a long ignition discharge duration (single or multi-strike ignition systems), the timing of the fuel injection and ignition kernel generation can be approximate, as the discharge essentially brackets the fuel cloud, or the combustion region there of, firing almost throughout the entire time period of the fuel cloud passing the ignitor.

With a short ignition pulse duration, the precise synchronization of the ignition event to the fuel injection event becomes essential, and high power short duration ignition discharge pulse makes this possible. This is a more complex process than ignition timing on standard port fuel injected engines, and includes course and fine timing adjustments.

Course tuning is achieved by adjusting the fuel injection event relative to the crank angle in order to achieve a desired ignition timing relative to the crank angle. Ignition timing must be directly tied to the fuel injection event as the ignition discharge must occur while injected combustible fuel or fuel mixture is present in its vicinity.

Precise adjustments of the ignition timing are done relative to the fuel injection event, and allow for the fine-tuning of the engine. This fine-tuning can be done directly by an engine control system or off of an engine map. Moreover, a direct synchronization with the fuel injector pulse allows for consistent and reliable compensation for variances of the injector pulse with regard to the injection-timing signal. Fuel injectors are not perfectly identical. Due to the manufacturing process, they may provide somewhat different injection timings for the identical electrical pulses or identical timing signals. These differences can be significant with respect to timing of ignition system.

However, we have observed that these variations can be compensated for by synchronizing the ignition system triggering event with either opening or closing of the fuel injector. This can be done by monitoring a change in pattern of the voltage and current waveforms announcing opening or closing of the fuel injector. A desired delay time can be introduced with respect to different points of the waveforms for precise ignition timing in relation to the fuel injection event. Anyone skilled in the art, however, realizes that there are other methods to monitor the status of the pintle.

In addition to compensating for the variances in the injectors there are two more distinct benefits from this approach. First, this method allows for more precise timing of a GDI engine. The reason for this is that with GDI engines, the ignition event is timed primarily to the fuel injection event rather than to the location of the piston, i.e., crank angle. Second, using this approach the system automatically compensates for variances in fuel pressure and injection system wear.

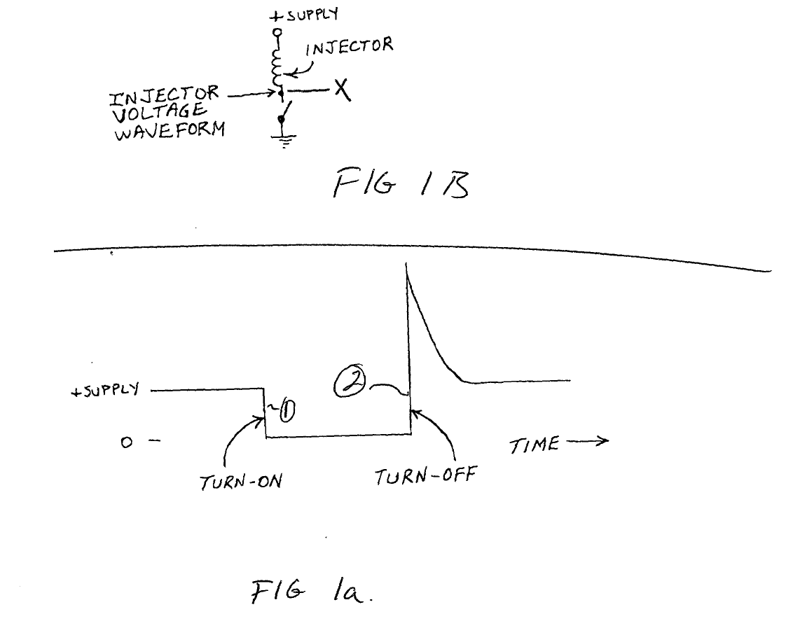

FIG. 1a is an example of an output voltage waveform of a FICHT injector coil. The waveform includes a first rise, denoted by reference numeral 1, and a second rise, denoted by reference numeral 2. The first rise 1 represents an opening of the injector and the second rise 2 represent a closing of the injector. This waveform is an example of the waveform which announces the opening (or closing) of the injector described above. Either of the first rise 1 or the second rise 2 may be used as the signal to trigger the ignition system.

As one of ordinary skill will realize, the voltage waveform shown in FIG. 1a is exemplary of a voltage waveform taken from node X shown in FIG. 1b.

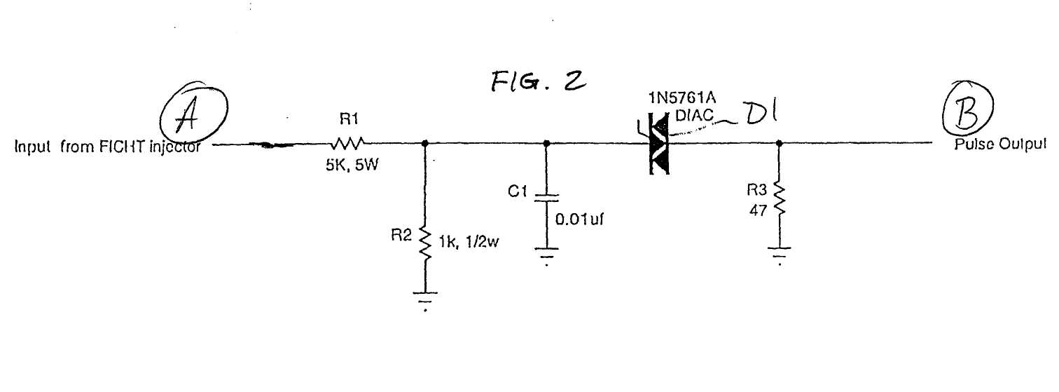

FIG. 2 shows an example of a circuit which can be used to trigger the ignition event based on the closing (FIG. 1, rise 2) of the injector. Of course, this circuit is but one of many which may be used to detect such a pulse and is provide by way of example only.

In the circuit, the input is received and passed as an input pulse to the ignition system. Of course, a time delay element may be interspersed between the output of the circuit and the input of the ignition system. As shown, the circuit is designed to trigger the ignition system based on the closing of the fuel injector, but one of ordinary skill in the art will readily realize these circuits could easily be modified to trigger the ignition system based on the opening (e.g., first rise 1) of the injector.

The circuit of FIG. 2 includes an input A which is connected to the output coil of an injector. The input A is connected to resistor R1 which is serial connected to ground through resistor R2. R1 is also serially connected to ground through capacitor C1. In this embodiment, the circuit also includes a DIAC D1 that is serially connected between capacitor C1 and another resistor R3. One terminal of resistor R3 is coupled to the output of the DIAC D1 and the other is coupled to ground. The following component values have achieved acceptable results: R1=5K, R2=1K, R3=47K, C1=0.01 f.

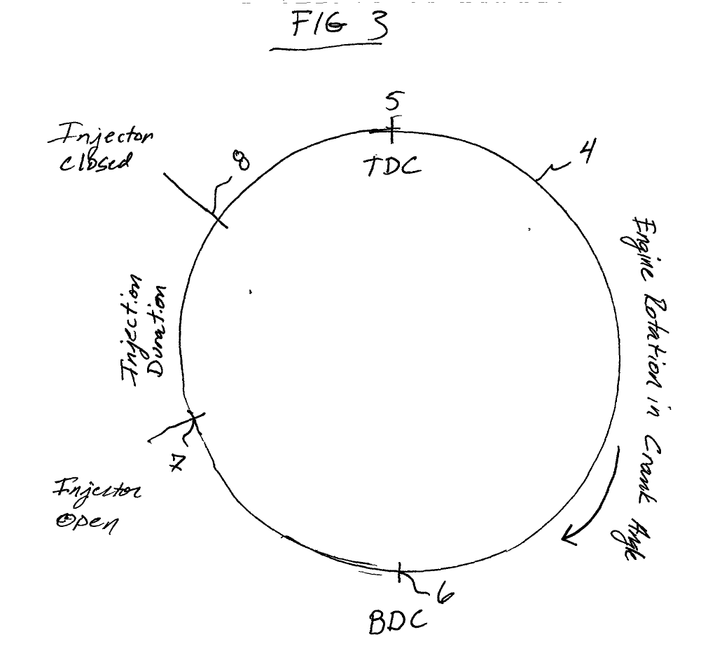

FIG. 3 depicts schematically the timing and duration of the injection and ignition events. In particular, FIG. 3 shows a clockwise circular diagram 4 that represents one revolution of an engine in terms crank angle. Node 5 represents the crank angle where the piston is at top-dead-center in the cylinder. Likewise, node 6 represents crank angle where the piston is at bottom-dead-center in the cylinder. The rotation that occurs between nodes 7 and 8 represents when injector is open with node 7 representing the opening of the injector and node 8 representing when the injector is closing.

Regardless of the monitoring device used, the principle remains the same—the mechanical orientation of the fuel injector, e.g. injector pintle, is what is used to determine when to trigger the ignition system.

Having just described several illustrative embodiments of the invention, various alterations, modifications and improvements will readily occur to those skilled in the art. Such alterations, modifications and improvements are intended to be in the spirit and scope of the invention. For example, the above description has discussed a FICHT injector but one of ordinary skill will readily realize that the teachings herein may be applied to other types of injectors as well. Accordingly, the foregoing description is by way of example only and is not intended as limiting.

What is claimed is:

1. A method of igniting a fuel charge of a Gasoline Direct Injection engine comprising:
providing an ignition pulse to an ignitor, the pulse having a duration of at least 1 μs and an average power of at least 500W.

2 The method of claim 1, wherein the step of providing includes providing the ignition pulse such that it has a peak power of 1500W sustained for at least 0.5 μs.

3. The method of claim 1, wherein the step of providing includes providing the ignition pulse for a duration of at least 7 μs.

4. The method of claim 1, wherein the step of providing includes providing the ignition pulse such that it has an average power of at least 10000W.

5. The method of claim 3, wherein the pulse has an average power of at least 2500W.

6. The method of claim 3, wherein the pulse has an average power of at least 10000W.

7. The method of claim 1, wherein the step of providing includes providing the ignition pulse such that it has a duration of at least 35 μs.

8. The method of claim 7, wherein the pulse has and average power of at least 2500W.

9. The method of claim 7, wherein the pulse has and average power of at least 10000W.

10. The method of any of claims 1-9, wherein the method is applied to a wall guided Gasoline Direct Injection engine.

11. The method of any of claims 1-9, wherein the method is applied to a spray guided Gasoline Direct Injection engine.

12. The method of any of claims 1-9, wherein the method is applied to a air guided Gasoline Direct Injection engine.

13. A method for adjusting a Gasoline Direct Injection engine timing comprising acts of:
(a) setting the ignition timing at a fixed delay from the injector timing;
(b) following act (a) adjusting the injector timing relative to the crank angle until the desired ignition timing relative to the injection timing is achieved.

14. A method of operating a Gasoline Direct Injection engine comprising, in sequence, acts of:
(a) determining a time when the fuel injector changes state;
(b) delaying for a predetermined time; and
(c) triggering an ignition sequence after the delay.

15. The method of claim 14, wherein the act of determining includes monitoring a waveform representing the state of an injector of the engine.

16. The method of claim 15, wherein act of determining includes an act of determining when the injector has opened.

17. The method of claim 15, wherein the act of determining includes an act of determining when the injector has closed.

18. A method of operating a Gasoline Direct Injection engine comprising:
coupling the ignition timing directly to the injector signal; and
adding a delay, wherein the delay is greater that or equal to 0.

19. The method of claim 18, wherein the act of coupling includes coupling the ignition timing directly to a portion of the injector signal representing injector pintle opening.

20. The method of claim 19, further comprising the act of adjusting the injector timing relative to the crank angle until the desired ignition timing relative to the injection timing is achieved.

21. The method of claim 18, wherein the act of coupling includes coupling the ignition timing directly to a portion of the injector signal representing injector pintle closing.

22. The method of claim 21, further comprising the act of adjusting the injector timing relative to the crank angle until the desired ignition timing relative to the injection timing is achieved.
